(19) United States
(12) Patent Application Publication
(10) Pub. No.: US 2025/0273897 A1
(43) Pub. Date: Aug. 28, 2025

(54) Connector Assembly and Female Connector Thereof

(71) Applicants: Dongguan Tarng Yu Electronics Co., Ltd., Dongguan City (CN); Tarng Yu Enterprise co., ltd., New Taipei City (TW)

(72) Inventors: TSUNG-CHI CHEN, New Taipei City (TW); MU-JUNG HUANG, New Taipei City (TW)

(21) Appl. No.: 19/062,352

(22) Filed: Feb. 25, 2025

(30) Foreign Application Priority Data
Feb. 26, 2024 (TW) 113201960

(51) Int. Cl. H01R 13/506; H01R 13/04; H01R 107/00

(52) U.S. Cl. CPC H01R 13/506; H01R 13/04; H01R 2107/00

(57) ABSTRACT

A connector assembly and female connector thereof, wherein the connector assembly comprises a male connector and a female connector, and the male connector is inserted into the female connector. The core of the female connector comprises an inserting guiding structure, which provides interference when the male connector is inserted in an incorrect inserting direction, thereby preventing the male connector from being incorrectly inserted into the female connector and ensuring that the male connector can be inserted into the female connector to provide power or signal transmission.

### CROSS-REFERENCE TO RELATED APPLICATIONS

This application claims the priority of Republic of China Patent Application No. 113201960 filed on Feb. 26, 2024, in the State Intellectual Property Office of the R.O.C., the disclosure of which is incorporated herein by reference.

### BACKGROUND OF THE INVENTION

### Field of the Invention

This application relates to signal transmission technology, and more specifically, to a connector assembly and female connector thereof that can prevent incorrect inserting direction of a male connector.

### Descriptions of the Related Art

In electrical equipment, it is often necessary to transmit electrical signals through a connector assembly composed of a female connector and a male connector. During the implementation of the connector assembly, the male connector can be inserted into the female connector to provide electrical signal transmission for the electrical equipment.

However, the insertion of the male connector into the female connector is usually directional. If the inserting direction of the male connector is incorrect, the electrical signal transmission of the connector assembly may suffer from voltage mismatches and other issues, thereby causing the electrical equipment to malfunction.

Therefore, how to provide a connector assembly and female connector thereof that prevents incorrect inserting direction of the male connector is indeed an urgent problem to be solved by those skilled in the relevant technical field.

### SUMMARY OF THE INVENTION

In view of the drawbacks of the prior art mentioned above, the present application provides a female connector, wherein the female connector provides insertion of a male connector in an inserting direction, comprises a female conductive terminal set, which comprises a first female terminal, a second female terminal, a third female terminal, and a fourth female terminal; and a female insulation core, which comprises a first female core lateral outer wall, a second female core lateral outer wall, a first female core longitudinal outer wall, a second female core longitudinal outer wall, a first female core lateral inner wall, a second female core lateral inner wall, and a first female core longitudinal inner wall; wherein the first female core lateral outer wall and the second female core lateral outer wall extend laterally, and the first female core longitudinal outer wall and the second female core longitudinal outer wall extend longitudinally; the first female core longitudinal outer wall is connected with the first female core lateral outer wall, and the second female core longitudinal outer wall is connected with the second female core lateral outer wall to form a female core major internal inserting space; the first female core lateral inner wall and the second female core lateral inner wall extend laterally, the first female core lateral inner wall is connected with the first female core longitudinal outer wall to form a first female major inserting guiding structure, and the first female core longitudinal inner wall is respectively connected with the first female core lateral outer wall, the second female core lateral outer wall, and the second female core lateral inner wall to form a second female major inserting guiding structure; wherein the first female major inserting guiding structure and the second female major inserting guiding structure partition the female core major internal inserting space into a first female major inserting guiding passage, a second female major inserting guiding passage, a first female major internal inserting subspace, a second female major internal inserting subspace, a third female major internal inserting subspace, and a fourth female major internal inserting subspace; the female insulation core is respectively mated with the first female terminal, the second female terminal, the third female terminal, and the fourth female terminal, allowing the first female terminal, the second female terminal, the third female terminal, and the fourth female terminal to respectively extend into the first female major internal inserting subspace, the second female major internal inserting subspace, the third female major internal inserting subspace, and the fourth female major internal inserting subspace; and the first female major inserting guiding passage is in continuity with the first female major internal inserting subspace and the second female major internal inserting subspace, and the second female major inserting guiding passage is in continuity with the third female major internal inserting subspace and the fourth female major internal inserting subspace, thereby guiding the insertion of the male connector in the inserting direction such that the male connector respectively enters the first female major internal inserting subspace, the second female major internal inserting subspace, the third female major internal inserting subspace, and the fourth female major internal inserting subspace to respectively insert the first female terminal, the second female terminal, the third female terminal, and the fourth female terminal.

Preferably, the female connector said above, wherein the female insulation core further comprises a first female core chamfer structure, which is respectively connected with the first female core lateral inner wall and the first female core longitudinal outer wall to form a first female major inserting foolproof structure.

Preferably, the female connector said above, wherein the female insulation core further comprises a second female core chamfer structure, which is respectively connected with the first female core longitudinal inner wall and the second female core lateral inner wall to form a second female major inserting foolproof structure.

Preferably, the female connector said above, wherein the first female major inserting guiding structure comprises a T-shaped cross-section; and the second female major inserting guiding structure comprises a T-shaped cross-section.

Preferably, the female connector said above, wherein the first female core lateral inner wall and the first female core longitudinal outer wall are substantially perpendicularly intersected, and the second female core lateral inner wall and the first female core longitudinal inner wall are substantially perpendicularly intersected.

Preferably, the female connector said above, wherein the female insulation core comprises a lateral extension plane, the first female core lateral inner wall and the second female core lateral inner wall respectively extend on the lateral extension plane, and the lateral extension plane is substantially perpendicularly intersected with the first female core longitudinal outer wall and the first female core longitudinal inner wall.

Preferably, the female connector said above, wherein the female conductive terminal set further comprises a fifth female terminal and a sixth female terminal, and the female insulation core further comprises a third female core longitudinal outer wall and a third female core lateral inner wall; the third female core longitudinal outer wall extends longitudinally and is respectively connected with the first female core lateral outer wall and the second female core lateral outer wall, allowing the second female core longitudinal outer wall, the third female core longitudinal outer wall, the first female core lateral outer wall, and the second female core lateral outer wall to form a female core minor internal inserting space; the third female core lateral inner wall is connected with the second female core longitudinal outer wall or the third female core longitudinal outer wall to form a first female minor inserting guiding structure; wherein the first female minor inserting guiding structure partitions the female core minor internal inserting space into a first female minor internal inserting subspace and a second female minor internal inserting subspace; the female insulation core is also mated with the fifth female terminal and the sixth female terminal, allowing the fifth female terminal and the sixth female terminal to respectively extend into the first female minor internal inserting subspace and the second female minor internal inserting subspace; and the first female minor internal inserting subspace is in continuity with the second female minor internal inserting subspace, thereby guiding the insertion of the male connector in the inserting direction such that the male connector respectively enters the first female minor internal inserting subspace and the second female minor internal inserting subspace to respectively insert the fifth female terminal and the sixth female terminal.

Preferably, the female connector said above, wherein the first female minor inserting guiding structure comprises a T-shaped cross-section.

Preferably, the female connector said above, wherein the third female core lateral inner wall and the second female core longitudinal outer wall or the third female core longitudinal outer wall are substantially perpendicularly intersected.

Preferably, the female connector said above, wherein the female insulation core comprises a lateral extension plane, the first female core lateral inner wall, the second female core lateral inner wall, and the third female core lateral inner wall respectively extend on the lateral extension plane, and the lateral extension plane is substantially perpendicularly intersected with the first female core longitudinal outer wall, the first female core longitudinal inner wall, the second female core longitudinal outer wall, and the third female core longitudinal outer wall.

Additionally, the present application provides a connector assembly, wherein the connector assembly comprising: a male connector, the male connector comprising: a male conductive terminal set, the male conductive terminal set comprising a first male terminal, a second male terminal, a third male terminal, and a fourth male terminal; and a male insulation core, the male insulation core being respectively mated with the first male terminal, the second male terminal, the third male terminal, and the fourth male terminal, and the male insulation core comprising a first male major inserting guiding structure, a second male major inserting guiding structure, a first male major inserting guiding passage, and a second male major inserting guiding passage; and a female connector, the male connector being inserted into the female connector in an inserting direction, the female connector comprising: a female conductive terminal set, the female conductive terminal set comprising a first female terminal, a second female terminal, a third female terminal, and a fourth female terminal; and a female insulation core, the female insulation core comprising a first female core lateral outer wall, a second female core lateral outer wall, a first female core longitudinal outer wall, a second female core longitudinal outer wall, a first female core lateral inner wall, a second female core lateral inner wall, and a first female core longitudinal inner wall; wherein, the first female core lateral outer wall and the second female core lateral outer wall extend laterally, respectively; the first female core longitudinal outer wall and the second female core longitudinal outer wall extend longitudinally, respectively; the first female core longitudinal outer wall is connected with the first female core lateral outer wall, and the second female core longitudinal outer wall is connected with the second female core lateral outer wall to form a female core major internal inserting space; the first female core lateral inner wall and the second female core lateral inner wall extend laterally, respectively; the first female core lateral inner wall is connected with the first female core longitudinal outer wall to form a first female major inserting guiding structure, and the first female core longitudinal inner wall is respectively connected with the first female core lateral outer wall, the second female core lateral outer wall, and the second female core lateral inner wall to form a second female major inserting guiding structure, wherein, the first female major inserting guiding structure and the second female major inserting guiding structure partition the female core major internal inserting space into a first female major inserting guiding passage, a second female major inserting guiding passage, a first female major internal inserting subspace, a second female major internal inserting subspace, a third female major internal inserting subspace, and a fourth female major internal inserting subspace; the female insulation core is respectively mated with the first female terminal, the second female terminal, the third female terminal, and the fourth female terminal, so that the first female terminal, the second female terminal, the third female terminal, and the fourth female terminal respectively extend into the first female major internal inserting subspace, the second female major internal inserting subspace, the third female major internal inserting subspace, and the fourth female major internal inserting subspace; and the first female major inserting guiding passage is in continuity with the first female major internal inserting subspace and the second female major internal inserting subspace, the second female major inserting guiding passage is in continuity with the third female major internal inserting subspace and the fourth female major internal inserting subspace, when the male connector is inserted into the female connector in the inserting direction, the first male major inserting guiding structure enters the first female major inserting guiding passage, and the second male major inserting guiding structure enters the second female major inserting guiding passage, the first female major inserting guiding structure enters the first male major inserting guiding passage, and the second female major inserting guiding structure enters the second male major inserting guiding passage, thereby providing guidance for the insertion of the male connector in the inserting direction, such that the first male terminal, the second male terminal, the third male terminal, and the fourth male terminal respectively enter the first female major internal inserting subspace, the second female major internal inserting subspace, the third female major internal inserting subspace, and the fourth female major internal inserting subspace, and are respectively inserted into the first female terminal, the second female terminal, the third female terminal, and the fourth female terminal.

Preferably, the connector assembly said above, wherein the male conductive terminal set further comprises a fifth male terminal and a sixth male terminal; and the male insulation core further comprises a first male minor inserting guiding structure and a first male minor inserting guiding passage; the female conductive terminal set further comprises a fifth female terminal and a sixth female terminal, and the female insulation core further comprises a third female core longitudinal outer wall and a third female core lateral inner wall, the third female core longitudinal outer wall extending longitudinally and being respectively connected with the first female core lateral outer wall and the second female core lateral outer wall, so that the second female core longitudinal outer wall, the third female core longitudinal outer wall, the first female core lateral outer wall, and the second female core lateral outer wall form a female core minor internal inserting space; the third female core lateral inner wall is connected with the second female core longitudinal outer wall to form a first female minor inserting guiding structure; wherein, the first female minor inserting guiding structure partitions the female core minor internal inserting space into a first female minor inserting guiding passage, a first female minor internal inserting subspace, and a second female minor internal inserting subspace; the first male minor inserting guiding passage is in continuity with the first female minor internal inserting subspace and the second female minor internal inserting subspace; the female insulation core is further mated with the fifth female terminal and the sixth female terminal, so that the fifth female terminal extends into the first female minor internal inserting subspace, and the sixth female terminal extends into the second female minor internal inserting subspace; and when the male connector is inserted into the female connector in the inserting direction, the first male minor inserting guiding structure enters the first female minor inserting guiding passage, the first female minor inserting guiding structure enters the first male minor inserting guiding passage, thereby providing guidance for the insertion of the male connector in the inserting direction, such that the fifth male terminal enters the first female minor internal inserting subspace, being inserted into the fifth female terminal, and the sixth male terminal enters the second female minor internal inserting subspace, being inserted into the sixth female terminal.

Compared to the prior art, the present application provides a connector assembly and female connector thereof, wherein the connector assembly comprises a male connector and a female connector, and the male connector is inserted into the female connector. The core of the female connector comprises an inserting guiding structure, which provides interference when the male connector is inserted in an incorrect inserting direction, thereby preventing the male connector from being incorrectly inserted into the female connector and ensuring that the male connector can be inserted into the female connector to provide power or signal transmission.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a three-dimensional schematic view of the connector assembly in an embodiment of the present application.

FIG. 2 is a three-dimensional schematic view of the connector assembly in an embodiment of the present application.

FIG. 3 is a bottom view schematic of the connector assembly in an embodiment of the present application.

FIG. 4 is a sectional schematic view of partial components of the connector assembly shown in FIG. 3, taken along line AA.

FIG. 5 is a sectional schematic view of partial components of the connector assembly shown in FIG. 3, taken along line A′A′.

FIG. 6 is a three-dimensional schematic view of the male connector in an embodiment of the present application.

FIG. 7 is a top view schematic of the male connector in an embodiment of the present application.

FIG. 8 is a top view schematic of the male connector in an embodiment of the present application.

FIG. 9 is a three-dimensional schematic view of the female connector in an embodiment of the present application.

FIG. 10 is a top view schematic of the female connector in an embodiment of the present application.

FIG. 11 is a top view schematic of the female connector in an embodiment of the present application.

FIG. 12 is a top view schematic of the female connector in an embodiment of the present application.

FIG. 13 is a top view schematic of the female connector in an embodiment of the present application.

FIG. 14 is a bottom view schematic of the female connector in an embodiment of the present application.

FIG. 15 is a sectional schematic view of partial components of the connector assembly shown in FIG. 14, taken along line BB.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

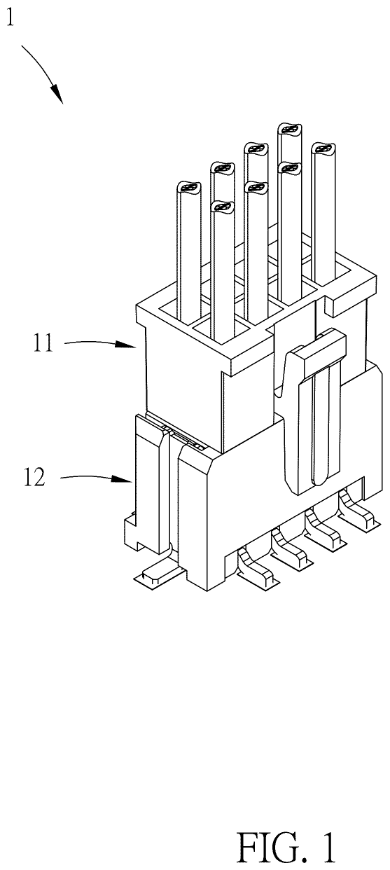

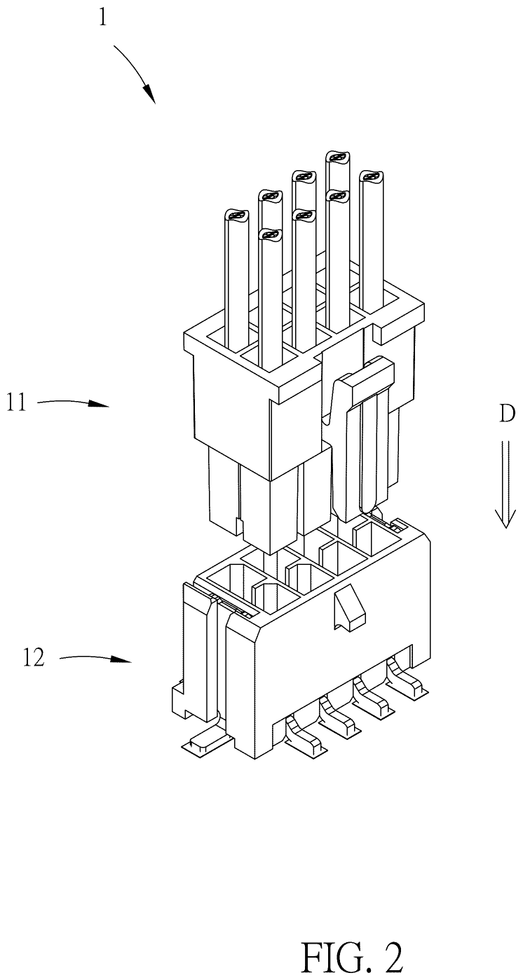

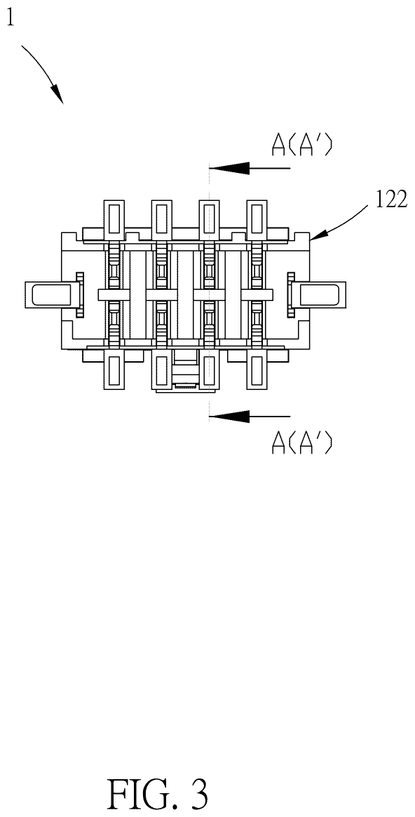

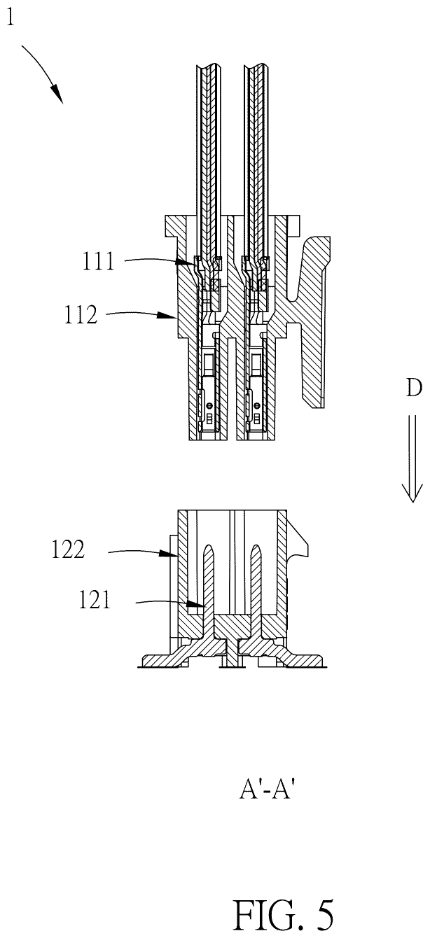

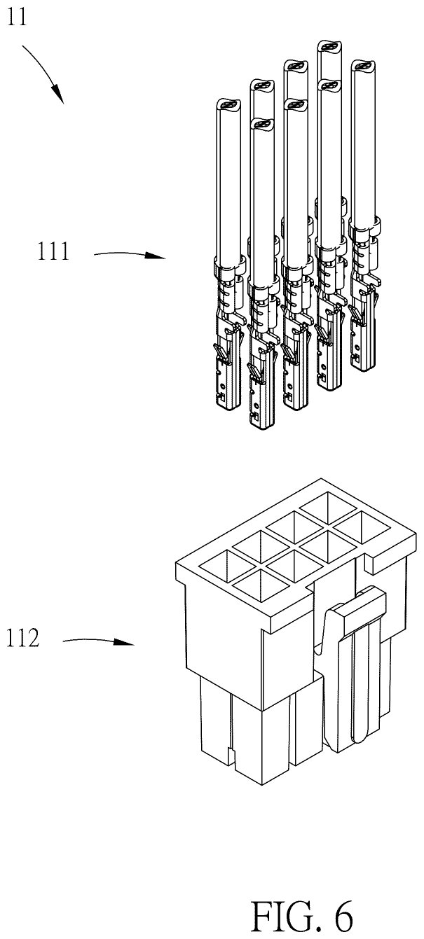

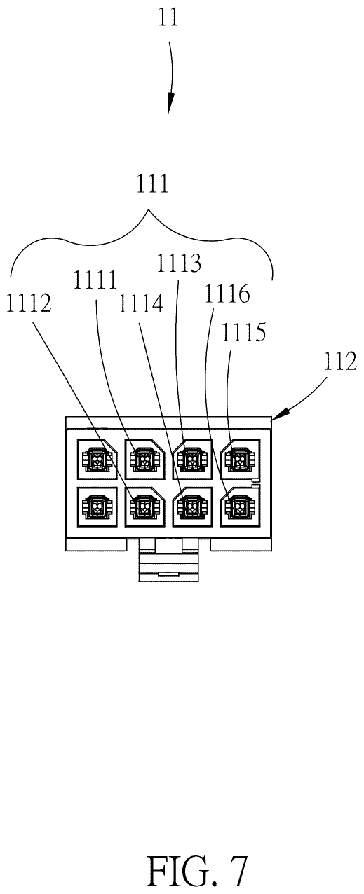

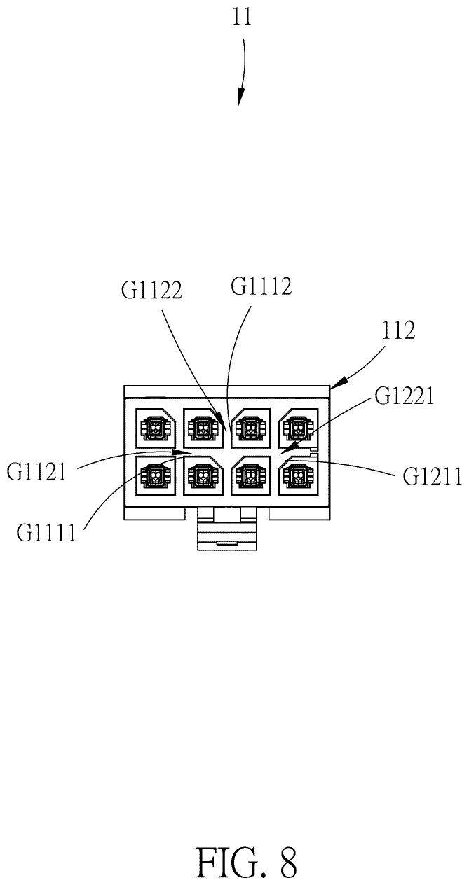

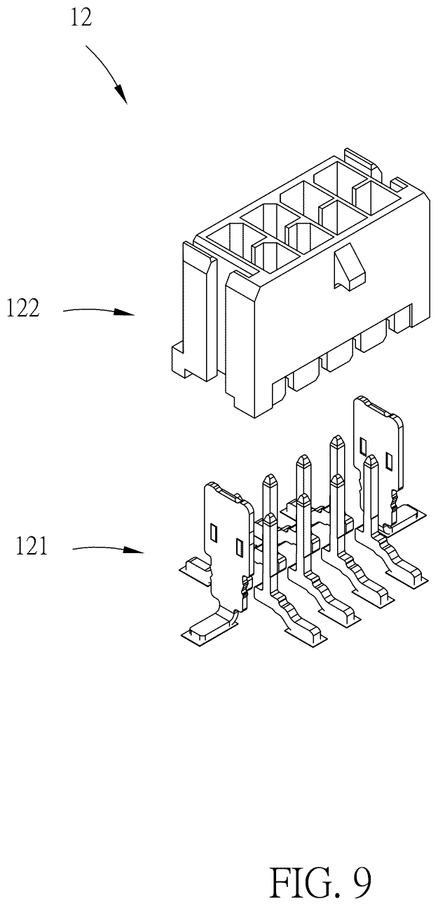

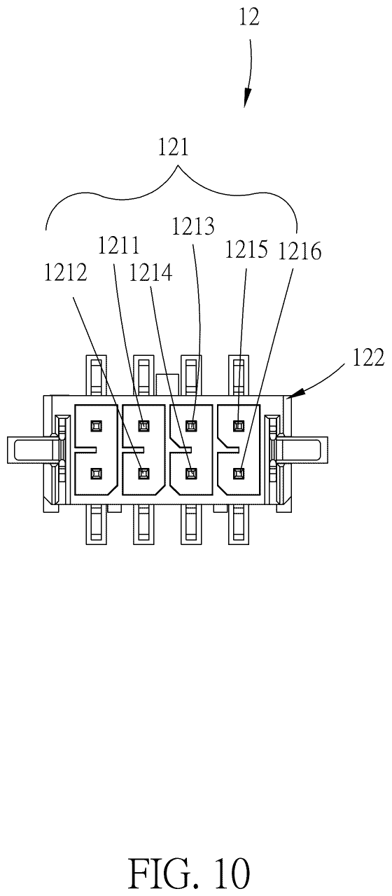

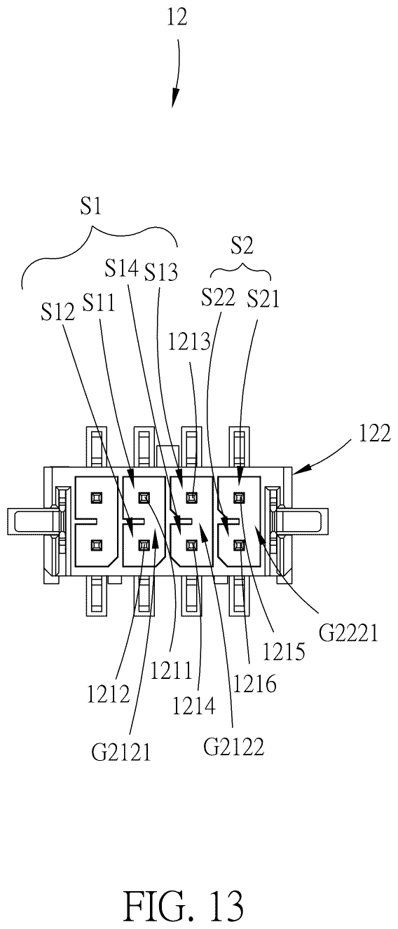

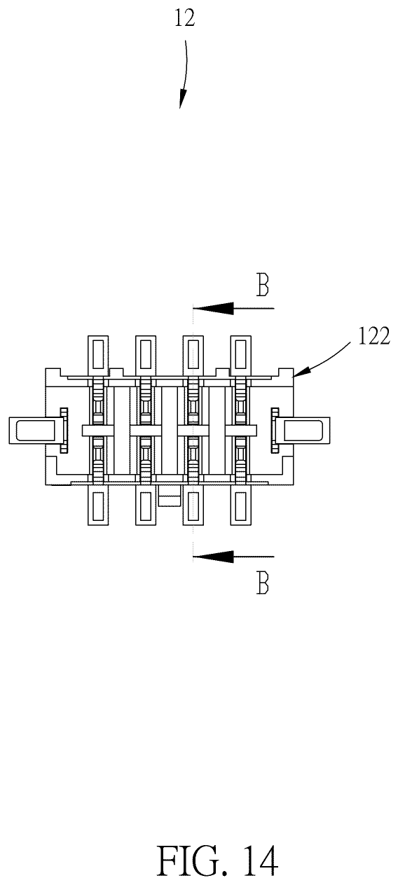

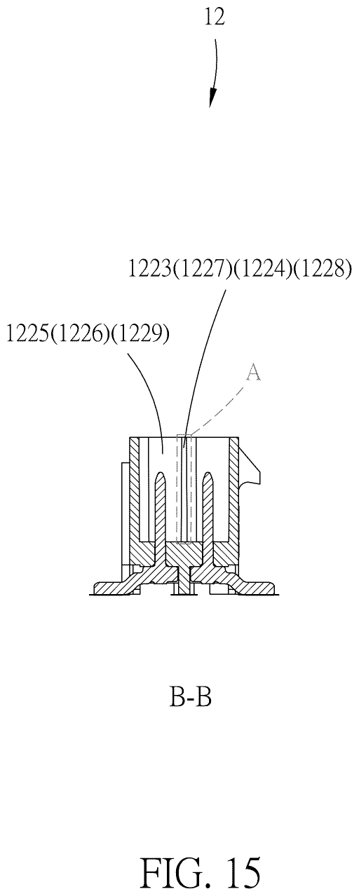

For a detailed description of the embodiments disclosed in the present application, please refer to FIGS. 1 to 15.

This application provides at least one connector assembly 1 that can be installed in electrical equipment. The connector assembly 1 comprises a male connector 11 and a female connector 12, wherein the male connector 11 can be inserted into the female connector 12 in an inserting direction D to provide power or signal transmission for the electrical equipment.

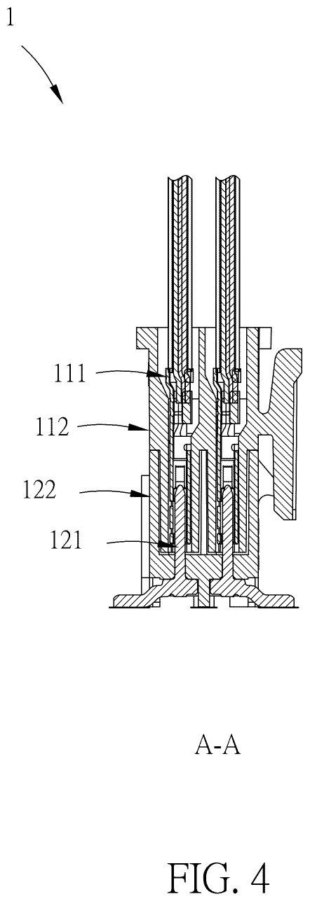

In the embodiments shown in FIGS. 4 to 5 and FIG. 7, the male connector 11 comprises a male conductive terminal set 111 and a male insulation core 112. The male conductive terminal set 111 comprises a first male terminal 1111, a second male terminal 1112, a third male terminal 1113, a fourth male terminal 1114, a fifth male terminal 1115, and a sixth male terminal 1116, which provide power or signal transmission. The male insulation core 112 is respectively mated with the first male terminal 1111, the second male terminal 1112, the third male terminal 1113, the fourth male terminal 1114, the fifth male terminal 1115, and the sixth male terminal 1116. Additionally, the male insulation core 112 comprises a first male major inserting guiding structure G1111, a second male major inserting guiding structure G1112, a first male major inserting guiding passage G1121, a second male major inserting guiding passage G1122, a first male minor inserting guiding structure G1211, and a first male minor inserting guiding passage G1221.

In the embodiments shown in FIGS. 4 to 5, FIGS. 9 to 10, and FIG. 13, the female connector 12 comprises a female conductive terminal set 121 and a female insulation core 122. The female conductive terminal set 121 comprises a first female terminal 1211, a second female terminal 1212, a third female terminal 1213, a fourth female terminal 1214, a fifth female terminal 1215, and a sixth female terminal 1216, which provide power or signal transmission. The female insulation core 122 comprises a first female core lateral outer wall 1221, a second female core lateral outer wall 1222, a first female core longitudinal outer wall 1223, a second female core longitudinal outer wall 1224, a first female core lateral inner wall 1225, a second female core lateral inner wall 1226, a first female core longitudinal inner wall 1227, a third female core longitudinal outer wall 1228, and a third female core lateral inner wall 1229.

In the above embodiments, the first female core lateral outer wall 1221 and the second female core lateral outer wall 1222 respectively extend laterally. The first female core longitudinal outer wall 1223, the second female core longitudinal outer wall 1224, and the third female core longitudinal outer wall 1228 respectively extend longitudinally. The first female core lateral inner wall 1225, the second female core lateral inner wall 1226, and the third female core lateral inner wall 1229 respectively extend laterally.

Additionally, the first female core longitudinal outer wall 1223 is connected with the first female core lateral outer wall 1221, and the second female core longitudinal outer wall 1224 is connected with the second female core lateral outer wall 1222, enabling the first female core longitudinal outer wall 1223, the second female core longitudinal outer wall 1224, the first female core lateral outer wall 1221, the second female core lateral outer wall 1222 to form a female core major internal inserting space S1. The third female core longitudinal outer wall 1228 is respectively in connected with the first female core lateral outer wall 1221 and the second female core lateral outer wall 1222, enabling the second female core longitudinal outer wall 1224, the third female core longitudinal outer wall 1228, the first female core lateral outer wall 1221, and the second female core lateral outer wall 1222 to form a female core minor internal inserting space S2.

It should be noted that the male connector 11 can be inserted into the female connector 12 within the female core major internal inserting space S1 and the female core minor internal inserting space S2.

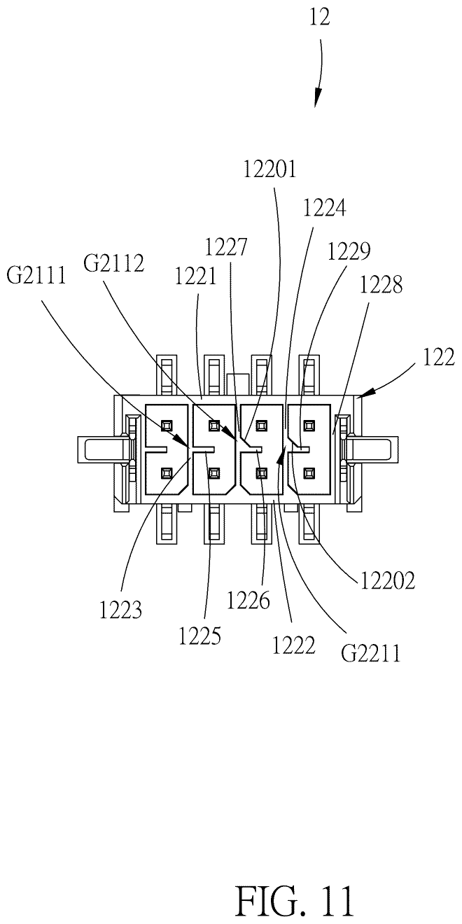

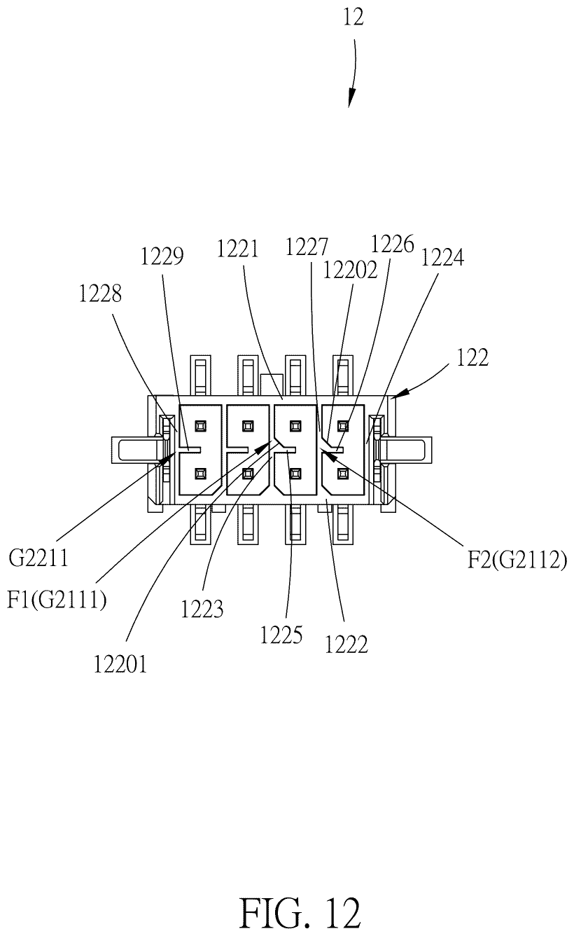

Additionally, the first female core lateral inner wall 1225 is connected with the first female core longitudinal outer wall 1223, enabling the first female core lateral inner wall 1225 and the first female core longitudinal outer wall 1223 to form a first female major inserting guiding structure G2111. The first female core longitudinal inner wall 1227 is respectively connected with the first female core lateral outer wall 1221, the second female core lateral outer wall 1222, and the second female core lateral inner wall 1226, enabling the first female core longitudinal inner wall 1227 and the second female core lateral inner wall 1226 to form a second female major inserting guiding structure G2112. As shown in FIG. 11, the third female core lateral inner wall 1229 is connected with the second female core longitudinal outer wall 1224, enabling the third female core lateral inner wall 1229 and the second female core longitudinal outer wall 1224 to form a first female minor inserting guiding structure G2211. As shown in FIG. 12, the third female core lateral inner wall 1229 is connected with the third female core longitudinal outer wall 1228, also enabling the third female core lateral inner wall 1229 and the third female core longitudinal outer wall 1228 to form a first female minor inserting guiding structure G2211.

In the above embodiments, the first female major inserting guiding structure G2111 and the second female major inserting guiding structure G2112 partition the female core major internal inserting space S1 into a first female major inserting guiding passage G2121, a second female major inserting guiding passage G2122, a first female major internal inserting subspace S11, a second female major internal inserting subspace S12, a third female major internal inserting subspace S13, and a fourth female major internal inserting subspace S14. The first female major inserting guiding passage G2121 is in continuity with the first female major internal inserting subspace S11 and the second female major internal inserting subspace S12, providing guidance for the insertion of the male connector 11 in the inserting direction D. The second female major inserting guiding passage G2122 is in continuity with the third female major internal inserting subspace S13 and the fourth female major internal inserting subspace S14, also providing guidance for the insertion of the male connector 11 in the inserting direction D. Thus, the male connector 11 can be inserted into the female connector 12 to provide power or signal transmission for the electrical equipment.

Additionally, the first female minor inserting guiding structure G2211 partitions the female core minor internal inserting space S2 into a first female minor inserting guiding passage G2221, a first female minor internal inserting subspace S21, and a second female minor internal inserting subspace S22. The first male minor inserting guiding passage G1221 is in continuity with the first female minor internal inserting subspace S21 and the second female minor internal inserting subspace S22, providing guidance for the insertion of the male connector 11 in the inserting direction D. Thus, the male connector 11 can be inserted into the female connector 12 to provide power or signal transmission for the electrical equipment.

The female insulation core 122 is respectively mated with and positioned for the first female terminal 1211, the second female terminal 1212, the third female terminal 1213, the fourth female terminal 1214, the fifth female terminal 1215, and the sixth female terminal 1216, ensuring separation among them. Each terminal respectively extends into the first female major internal inserting subspace S11, the second female major internal inserting subspace S12, the third female major internal inserting subspace S13, the fourth female major internal inserting subspace S14, the first female minor internal inserting subspace S21, and the second female minor internal inserting subspace S22.

It should be noted that when the male connector 11 is inserted into the female connector 12 in the inserting direction D, the first male major inserting guiding structure G1111, the second male major inserting guiding structure G1112, and the first male minor inserting guiding structure G1211 respectively enter the first female major inserting guiding passage G2121, the second female major inserting guiding passage G2122, and the first female minor inserting guiding passage G2221. The first female major inserting guiding structure G2111, the second female major inserting guiding structure G2112, and the first female minor inserting guiding structure G2211 respectively enter the first male major inserting guiding passage G1121, the second male major inserting guiding passage G1122, and the first male minor inserting guiding passage G1221, thereby providing guidance for the insertion of the male connector 11 in the inserting direction D. This ensures that the first male terminal 1111, the second male terminal 1112, the third male terminal 1113, the fourth male terminal 1114, the fifth male terminal 1115, and the sixth male terminal 1116 respectively enter the first female major internal inserting subspace S11, the second female major internal inserting subspace S12, the third female major internal inserting subspace S13, the fourth female major internal inserting subspace S14, the first female minor internal inserting subspace S21, and the second female minor internal inserting subspace S22, and are respectively inserted into the first female terminal 1211, the second female terminal 1212, the third female terminal 1213, the fourth female terminal 1214, the fifth female terminal 1215, and the sixth female terminal 1216 to provide power or signal transmission for electrical equipment.

In the embodiment shown in FIGS. 11 to 12, the first female major inserting guiding structure G2111 comprises a T-shaped cross-section that forms a foolproof structure; the second female major inserting guiding structure G2112 also comprises a T-shaped cross-section forming a foolproof structure; and the first female minor inserting guiding structure G2211 also comprises a T-shaped cross-section forming a foolproof structure. Thus, the foolproof structures provide interference when the male connector 11 is inserted incorrectly in the inserting direction D, preventing the male connector 11 from being inserted into the female connector 12 in the wrong direction.

Additionally, in the embodiment shown in FIGS. 11 to 12, the first female core lateral inner wall 1225 and the first female core longitudinal outer wall 1223 are substantially perpendicularly intersected to form a foolproof structure; the second female core lateral inner wall 1226 and the first female core longitudinal inner wall 1227 are substantially perpendicularly intersected to form a foolproof structure; and the third female core lateral inner wall 1229 and either the second female core longitudinal outer wall 1224 or the third female core longitudinal outer wall 1228 are substantially perpendicularly intersected to form a foolproof structure. Thus, these foolproof structures provide interference when the male connector 11 is inserted incorrectly in the inserting direction D, preventing the male connector 11 from being inserted into the female connector 12 in the wrong direction.

Furthermore, the female insulation core 122 can define a lateral extension plane A, wherein the first female core lateral inner wall 1225, the second female core lateral inner wall 1226, and the second female core lateral inner wall 1226 respectively extend along the lateral extension plane A to form a foolproof structure. Additionally, the first female core longitudinal outer wall 1223, the first female core longitudinal inner wall 1227, the second female core longitudinal outer wall 1224, and the third female core longitudinal outer wall 1228 respectively substantially perpendicularly intersect the lateral extension plane A to form a foolproof structure. Thus, these foolproof structures provide interference when the male connector 11 is inserted incorrectly in the inserting direction D, preventing the male connector 11 from being inserted into the female connector 12 in the wrong direction.

Furthermore, in the embodiment shown in FIGS. 11 to 12, the female insulation core 122 also comprises a first female core chamfer structure 12201 and a second female core chamfer structure 12202. The first female core chamfer structure 12201 is respectively connected with the first female core lateral inner wall 1225 and the first female core longitudinal outer wall 1223 to form a first female major inserting foolproof structure F1. The second female core chamfer structure 12202 is respectively connected with the first female core longitudinal inner wall 1227 and the second female core lateral inner wall 1226 to form a second female major inserting foolproof structure F2. It should be noted that the first female major inserting foolproof structure F1 and the second female major inserting foolproof structure F2 provide interference when the male connector 11 is inserted incorrectly in the inserting direction D, preventing the male connector 11 from being inserted into the female connector 12 in the wrong direction.

It should be noted that in the connector assembly and female connector thereof of the present application, certain components may be omitted. For example, the connector assembly may optionally comprise only the male connector and the female connector. The male connector comprises a male conductive terminal set and a male insulation core. The male conductive terminal set consists of a first male terminal, a second male terminal, a third male terminal, and a fourth male terminal. The male insulation core is respectively mated with the first male terminal, the second male terminal, the third male terminal, and the fourth male terminal. Additionally, the male insulation core comprises a first male major inserting guiding structure, a second male major inserting guiding structure, a first male major inserting guiding passage, and a second male major inserting guiding passage. The male connector is inserted into the female connector in the inserting direction. The female connector comprises a female conductive terminal set and a female insulation core. The female conductive terminal set consists of a first female terminal, a second female terminal, a third female terminal, and a fourth female terminal. The female insulation core comprises a first female core lateral outer wall, a second female core lateral outer wall, a first female core longitudinal outer wall, a second female core longitudinal outer wall, a first female core lateral inner wall, a second female core lateral inner wall, and a first female core longitudinal inner wall. The first female core lateral outer wall and the second female core lateral outer wall extend laterally, respectively. The first female core longitudinal outer wall and the second female core longitudinal outer wall extend longitudinally, respectively. The first female core longitudinal outer wall is connected with the first female core lateral outer wall, and the second female core longitudinal outer wall is connected with the second female core lateral outer wall, forming a female core major internal inserting space. The first female core lateral inner wall and the second female core lateral inner wall extend laterally, respectively. The first female core lateral inner wall is connected with the first female core longitudinal outer wall, forming a first female major inserting guiding structure. The first female core longitudinal inner wall is respectively connected with the first female core lateral outer wall, the second female core lateral outer wall, and the second female core lateral inner wall, forming a second female major inserting guiding structure. The first female major inserting guiding structure and the second female major inserting guiding structure divide the female core major internal inserting space into the first female major inserting guiding passage, the second female major inserting guiding passage, the first female major internal inserting subspace, the second female major internal inserting subspace, the third female major internal inserting subspace, and the fourth female major internal inserting subspace. The female insulation core is respectively mated with the first female terminal, the second female terminal, the third female terminal, and the fourth female terminal, allowing them to extend into the first female major internal inserting subspace, the second female major internal inserting subspace, the third female major internal inserting subspace, and the fourth female major internal inserting subspace, respectively. The first female major inserting guiding passage is in continuity with the first female major internal inserting subspace and the second female major internal inserting subspace. The second female major inserting guiding passage is in continuity with the third female major internal inserting subspace and the fourth female major internal inserting subspace. When the male connector is inserted into the female connector in the inserting direction, the first male major inserting guiding structure and the second male major inserting guiding structure enter the first female major inserting guiding passage and the second female major inserting guiding passage, respectively. Simultaneously, the first female major inserting guiding structure and the second female major inserting guiding structure enter the first male major inserting guiding passage and the second male major inserting guiding passage, respectively. This configuration provides guidance for the insertion of the male connector in the inserting direction, ensuring that the first male terminal, the second male terminal, the third male terminal, and the fourth male terminal respectively enter the first female major internal inserting subspace, the second female major internal inserting subspace, the third female major internal inserting subspace, and the fourth female major internal inserting subspace, thereby achieving proper insertion with the first female terminal, the second female terminal, the third female terminal, and the fourth female terminal.

Additionally, the female connector is optionally configured to comprise only: the female conductive terminal set and the female insulation core. The female conductive terminal set comprises a first female terminal, a second female terminal, a third female terminal, and a fourth female terminal. The female insulation core comprises a first female core lateral outer wall, a second female core lateral outer wall, a first female core longitudinal outer wall, a second female core longitudinal outer wall, a first female core lateral inner wall, a second female core lateral inner wall, and a first female core longitudinal inner wall. The first female core lateral outer wall and the second female core lateral outer wall extend laterally, respectively, and the first female core longitudinal outer wall and the second female core longitudinal outer wall extend longitudinally, respectively. The first female core longitudinal outer wall is connected with the first female core lateral outer wall, and the second female core longitudinal outer wall is connected with the second female core lateral outer wall to form the female core major internal inserting space. The first female core lateral inner wall and the second female core lateral inner wall respectively extend laterally, respectively, wherein the first female core lateral inner wall is connected with the first female core longitudinal outer wall to form the first female major inserting guiding structure, and the first female core longitudinal inner wall is connected with the first female core lateral outer wall, the second female core lateral outer wall, and the second female core lateral inner wall to form the second female major inserting guiding structure. The first female major inserting guiding structure and the second female major inserting guiding structure partition the female core major internal inserting space into a first female major inserting guiding passage, a second female major inserting guiding passage, a first female major internal inserting subspace, a second female major internal inserting subspace, a third female major internal inserting subspace, and a fourth female major internal inserting subspace. The female insulation core is respectively mated with the first female terminal, the second female terminal, the third female terminal, and the fourth female terminal, such that the first female terminal, the second female terminal, the third female terminal, and the fourth female terminal respectively extend into the first female major internal inserting subspace, the second female major internal inserting subspace, the third female major internal inserting subspace, and the fourth female major internal inserting subspace. The first female major inserting guiding passage is in continuity with the first female major internal inserting subspace and the second female major internal inserting subspace, and the second female major inserting guiding passage is in continuity with the third female major internal inserting subspace and the fourth female major internal inserting subspace, thereby providing guidance for the insertion of the male connector in the inserting direction, so that the male connector respectively enters the first female major internal inserting subspace, the second female major internal inserting subspace, the third female major internal inserting subspace, and the fourth female major internal inserting subspace to be inserted into the first female terminal, the second female terminal, the third female terminal, and the fourth female terminal, respectively.

In summary, the present application provides a connector assembly and female connector thereof, wherein the connector assembly comprises a male connector and a female connector, and the male connector is inserted into the female connector. The core of the female connector comprises an inserting guiding structure, which provides interference when the male connector is inserted in an incorrect inserting direction, thereby preventing the male connector from being incorrectly inserted into the female connector and ensuring that the male connector can be inserted into the female connector to provide power or signal transmission.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. A female connector, which provides insertion of a male connector in an inserting direction, comprises
a female conductive terminal set, which comprises a first female terminal, a second female terminal, a third female terminal, and a fourth female terminal; and
a female insulation core, which comprises a first female core lateral outer wall, a second female core lateral outer wall, a first female core longitudinal outer wall, a second female core longitudinal outer wall, a first female core lateral inner wall, a second female core lateral inner wall, and a first female core longitudinal inner wall; wherein
the first female core lateral outer wall and the second female core lateral outer wall extend laterally, and the first female core longitudinal outer wall and the second female core longitudinal outer wall extend longitudinally; the first female core longitudinal outer walls in continuity with the first female core lateral outer wall, and the second female core longitudinal outer wall is in continuity with the second female core lateral outer wall to form a female core major internal inserting space;
the first female core lateral inner wall and the second female core lateral inner wall extend laterally, the first female core lateral inner wall is in continuity with the first female core longitudinal outer wall to form a first female major inserting guiding structure, and the first female core longitudinal inner wall is respectively in continuity with the first female core lateral outer wall, the second female core lateral outer wall, and the second female core lateral inner wall to form a second female major inserting guiding structure; wherein
the first female major inserting guiding structure and the second female major inserting guiding structure partition the female core major internal inserting space into a first female major inserting guiding passage, a second female major inserting guiding passage, a first female major internal inserting subspace, a second female major internal inserting subspace, a third female major internal inserting subspace, and a fourth female major internal inserting subspace;
the female insulation core is respectively mated with the first female terminal, the second female terminal, the third female terminal, and the fourth female terminal, allowing the first female terminal, the second female terminal, the third female terminal, and the fourth female terminal to respectively extend into the first female major internal inserting subspace, the second female major internal inserting subspace, the third female major internal inserting subspace, and the fourth female major internal inserting subspace; and
the first female major inserting guiding passage is in continuity with the first female major internal inserting subspace and the second female major internal inserting subspace, and the second female major inserting guiding passage is in continuity with the third female major internal inserting subspace and the fourth female major internal inserting subspace, thereby guiding the insertion of the male connector in the inserting direction such that the male connector respectively enters the first female major internal inserting subspace, the second female major internal inserting subspace, the third female major internal inserting subspace, and the fourth female major internal inserting subspace to respectively insert the first female terminal, the second female terminal, the third female terminal, and the fourth female terminal.

2. The female connector of claim 1, wherein the female insulation core further comprises a first female core chamfer structure, which is respectively connected with the first female core lateral inner wall and the first female core longitudinal outer wall to form a first female major inserting foolproof structure.

3. The female connector of claim 2, wherein the female insulation core further comprises a second female core chamfer structure, which is respectively connected with the first female core longitudinal inner wall and the second female core lateral inner wall to form a second female major inserting foolproof structure.

4. The female connector of claim 1, wherein the first female major inserting guiding structure comprises a T-shaped cross-section; and the second female major inserting guiding structure comprises a T-shaped cross-section.

5. The female connector of claim 1, wherein the first female core lateral inner wall and the first female core longitudinal outer wall are substantially perpendicularly intersected, and the second female core lateral inner wall and the first female core longitudinal inner wall are substantially perpendicularly intersected.

6. The female connector of claim 1, wherein the female insulation core comprises a lateral extension plane, the first female core lateral inner wall and the second female core lateral inner wall respectively extend on the lateral extension plane, and the lateral extension plane is substantially perpendicularly intersected with the first female core longitudinal outer wall and the first female core longitudinal inner wall.

7. The female connector of claim 1, wherein the female conductive terminal set further comprises a fifth female terminal and a sixth female terminal, and the female insulation core further comprises a third female core longitudinal outer wall and a third female core lateral inner wall; the third female core longitudinal outer wall extends longitudinally and is respectively connected with the first female core lateral outer wall and the second female core lateral outer wall, allowing the second female core longitudinal outer wall, the third female core longitudinal outer wall, the first female core lateral outer wall, and the second female core lateral outer wall to form a female core minor internal inserting space;
the third female core lateral inner wall is connected with the second female core longitudinal outer wall or the third female core longitudinal outer wall to form a first female minor inserting guiding structure; wherein
the first female minor inserting guiding structure partitions the female core minor internal inserting space into a first female minor internal inserting subspace and a second female minor internal inserting subspace;
the female insulation core is also mated with the fifth female terminal and the sixth female terminal, allowing the fifth female terminal and the sixth female terminal to respectively extend into the first female minor internal inserting subspace and the second female minor internal inserting subspace; and
the first female minor internal inserting subspace is in continuity with the second female minor internal inserting subspace, thereby guiding the insertion of the male connector in the inserting direction such that the male connector respectively enters the first female minor internal inserting subspace and the second female minor internal inserting subspace to respectively insert the fifth female terminal and the sixth female terminal.

8. The female connector of claim 7, wherein the first female minor inserting guiding structure comprises a T-shaped cross-section.

9. The female connector of claim 7, wherein the third female core lateral inner wall and the second female core longitudinal outer wall or the third female core longitudinal outer wall are substantially perpendicularly intersected.

10. The female connector of claim 7, wherein the female insulation core comprises a lateral extension plane, the first female core lateral inner wall, the second female core lateral inner wall, and the third female core lateral inner wall respectively extend on the lateral extension plane, and the lateral extension plane is substantially perpendicularly intersected with the first female core longitudinal outer wall, the first female core longitudinal inner wall, the second female core longitudinal outer wall, and the third female core longitudinal outer wall.

11. A connector assembly, the connector assembly comprising:
a male connector, the male connector comprising:
a male conductive terminal set, the male conductive terminal set comprising a first male terminal, a second male terminal, a third male terminal, and a fourth male terminal; and
a male insulation core, the male insulation core being respectively mated with the first male terminal, the second male terminal, the third male terminal, and the fourth male terminal, and the male insulation core comprising a first male major inserting guiding structure, a second male major inserting guiding structure, a first male major inserting guiding passage, and a second male major inserting guiding passage; and
a female connector, the male connector being inserted into the female connector in an inserting direction, the female connector comprising:
a female conductive terminal set, the female conductive terminal set comprising a first female terminal, a second female terminal, a third female terminal, and a fourth female terminal; and
a female insulation core, the female insulation core comprising a first female core lateral outer wall, a second female core lateral outer wall, a first female core longitudinal outer wall, a second female core longitudinal outer wall, a first female core lateral inner wall, a second female core lateral inner wall, and a first female core longitudinal inner wall; wherein,
the first female core lateral outer wall and the second female core lateral outer wall extend laterally, respectively; the first female core longitudinal outer wall and the second female core longitudinal outer wall extend longitudinally, respectively; the first female core longitudinal outer wall is connected with the first female core lateral outer wall, and the second female core longitudinal outer wall is connected with the second female core lateral outer wall to form a female core major internal inserting space;
the first female core lateral inner wall and the second female core lateral inner wall extend laterally, respectively; the first female core lateral inner wall is connected with the first female core longitudinal outer wall to form a first female major inserting guiding structure, and the first female core longitudinal inner wall is respectively connected with the first female core lateral outer wall, the second female core lateral outer wall, and the second female core lateral inner wall to form a second female major inserting guiding structure, wherein,
the first female major inserting guiding structure and the second female major inserting guiding structure partition the female core major internal inserting space into a first female major inserting guiding passage, a second female major inserting guiding passage, a first female major internal inserting subspace, a second female major internal inserting subspace, a third female major internal inserting subspace, and a fourth female major internal inserting subspace;
the female insulation core is respectively mated with the first female terminal, the second female terminal, the third female terminal, and the fourth female terminal, so that the first female terminal, the second female terminal, the third female terminal, and the fourth female terminal respectively extend into the first female major internal inserting subspace, the second female major internal inserting subspace, the third female major internal inserting subspace, and the fourth female major internal inserting subspace; and
the first female major inserting guiding passage is in continuity with the first female major internal inserting subspace and the second female major internal inserting subspace, the second female major inserting guiding passage is in continuity with the third female major internal inserting subspace and the fourth female major internal inserting subspace,
when the male connector is inserted into the female connector in the inserting direction, the first male major inserting guiding structure enters the first female major inserting guiding passage, and the second male major inserting guiding structure enters the second female major inserting guiding passage, the first female major inserting guiding structure enters the first male major inserting guiding passage, and the second female major inserting guiding structure enters the second male major inserting guiding passage, thereby providing guidance for the insertion of the male connector in the inserting direction, such that the first male terminal, the second male terminal, the third male terminal, and the fourth male terminal respectively enter the first female major internal inserting subspace, the second female major internal inserting subspace, the third female major internal inserting subspace, and the fourth female major internal inserting subspace, and are respectively inserted into the first female terminal, the second female terminal, the third female terminal, and the fourth female terminal.

12. The connector assembly of claim 11, wherein the male conductive terminal set further comprises a fifth male terminal and a sixth male terminal; and
the male insulation core further comprises a first male minor inserting guiding structure and a first male minor inserting guiding passage;
the female conductive terminal set further comprises a fifth female terminal and a sixth female terminal, and the female insulation core further comprises a third female core longitudinal outer wall and a third female core lateral inner wall, the third female core longitudinal outer wall extending longitudinally and being respectively connected with the first female core lateral outer wall and the second female core lateral outer wall, so that the second female core longitudinal outer wall, the third female core longitudinal outer wall, the first female core lateral outer wall, and the second female core lateral outer wall form a female core minor internal inserting space;
the third female core lateral inner wall is connected with the second female core longitudinal outer wall to form a first female minor inserting guiding structure; wherein,
the first female minor inserting guiding structure partitions the female core minor internal inserting space into a first female minor inserting guiding passage, a first female minor internal inserting subspace, and a second female minor internal inserting subspace;
the first male minor inserting guiding passage is in continuity with the first female minor internal inserting subspace and the second female minor internal inserting subspace;
the female insulation core is further mated with the fifth female terminal and the sixth female terminal, so that the fifth female terminal extends into the first female minor internal inserting subspace, and the sixth female terminal extends into the second female minor internal inserting subspace; and
when the male connector is inserted into the female connector in the inserting direction, the first male minor inserting guiding structure enters the first female minor inserting guiding passage, the first female minor inserting guiding structure enters the first male minor inserting guiding passage, thereby providing guidance for the insertion of the male connector in the inserting direction, such that the fifth male terminal enters the first female minor internal inserting subspace, being inserted into the fifth female terminal, and the sixth male terminal enters the second female minor internal inserting subspace, being inserted into the sixth female terminal.
